(19) United States
(12) Patent Application Publication
(10) Pub. No.: US 2005/0008559 A1
(43) Pub. Date: Jan. 13, 2005

(54) Nitrogen-containing carbonaceous material and process for production thereof

(76) Inventors: Masafumi Ata, Kanagawa (JP); Huang Houjin, Kanagawa (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/866,848

(22) Filed: Jun. 14, 2004

(30) Foreign Application Priority Data
Jun. 16, 2003 (JP) P2003-170312

(51) Int. Cl. C01B 31/02

(52) U.S. Cl. 423/445 B

(57) ABSTRACT

The present invention provides a nitrogen-containing carbonaceous material which has a new structure to supersede endohedral fullerenes and will find use in a broad range of applications, and a process capable of producing the same easily. The nitrogen-containing carbonaceous material comprises a plurality of spherical carbon molecules represented by Cₙ (where n denotes an integer which permits carbon atoms to form a geometrically spherical compound) and nitrogen atoms (or ions or radicals thereof) added to at least a portion of said spherical carbon molecules inside or outside. Also, the nitrogen-containing carbonaceous material comprises a plurality of spherical carbon molecules joined together through a nitrogen atom or its ion or radical. A process for producing a nitrogen-containing carbonaceous material which comprises a step of exciting nitrogen molecules with a high-frequency plasma in a nitrogen-containing atmosphere, thereby forming radicals or ions of nitrogen atoms, a step of vaporizing spherical carbon molecules, and a step of reacting said radicals or ions of nitrogen atoms with said spherical carbon molecules.

### BACKGROUND OF THE INVENTION

The present invention relates to a nitrogen-containing carbonaceous material and a process for production thereof.

The high-frequency plasma process is essentially different from the photoprocess in which the excitation of the plasma gas and target molecules depends on the symmetry of molecules.

In 1993, the present inventors carried out polymerization of fullerene with the help of high-frequency plasma in place of light.

The reason for this is that fullerene has high symmetry (as indicated by point group Iₕ) and hence is poor in efficiency of photoexcitation by absorption in the visible region because one-electron excitation from Hᵤ to T₁ᵤ is forbidden on account of the symmetry. (Takahashi, N.; Dock, H.; Matsuzawa, N.; Ata, M. J.; Applied Physics 1993, 74, 5790)

In addition, plasma offers the advantage of being able to excite the atmospheric gas more efficiently than light.

Hitherto, high-frequency plasma has been used as means for excitation. Polymerization of fullerene by plasma has been thought of as means to improve mobility and stability for prevention of oxygen diffusion.

On the other hand, the research on endohedral metallo-fullerene, which started with La@C₈₂ in 1991, is widely spreading from the viewpoint of stable spin and formation mechanism.

Endohedral fullerenes have come to embrace fullerenes encapsulating typical elements, such as nitrogen and phosphorus, which are formed by ion implantation.

Recently, the stable spin is expected to find use as the quantum bit and quantum arithmetic element. It is attracting attention on account of its long spin relaxation time.

It has recently been reported that it is possible to form nitrogen-endohedral fullerene by using capacitively-coupled high-frequency plasma provided with internally parallel flat electrodes, in place of ion implantation which needs large-scale apparatus and complex processes. (See non-patent document 1 below.)

However, it has been found that endohedral fullerenes are not formed by inductively-coupled plasma with the high-frequency coil installed outside the reaction tube.

The foregoing suggests that nitrogen endohedral fullerenes are formed in the surroundings of the high-frequency electrodes in which there exists a steep gradient of electric field due to self bias, not in the non-equilibrium reaction field of capacitively-coupled high-frequency plasma.

Endohedral fullerenes are formed as the result of collision of fullerene molecules with nitrogen cations which have been excited by plasma around the electrodes in the self-bias state, and plasma excites nitrogen molecules into cations or radicals.

It is important that the nitrogen cations are accelerated around the electrodes between which there exists a steep gradient of electric field. The above-mentioned process should properly referred to as “plasma-based ion implantation”.

Non-patent document 1: “N—C₆₀ Formation in Nitrogen Plasma”, H. Huang, M. Ata, and M. Ramm; Chemical Communications, 2076-77 (2002).

### SUMMARY OF THE INVENTION

The present inventors investigated a new structure which will supersede the above-mentioned endohedral fullerene which is depicted as having nitrogen atoms encapsulated inside.

It is an object of the present invention to provide a nitrogen-containing carbonaceous material and a process for production thereof. The nitrogen-containing carbonaceous material has a new structure which will supersede the above-mentioned endohedral fullerenes. It is easy to produce and is expected to find a variety of applications.

The present inventors extensively studies a new structure which will supersede the above-mentioned conventional endohedral fullerene with nitrogen or the like.

As the result, the present inventors found for the first time a new structure which can be easily formed by means of high-frequency plasma and which will find a broad range of applications.

The present invention is directed to a nitrogen-containing carbonaceous material which comprises a plurality of spherical carbon molecules represented by Cₙ (where n denotes an integer which permits carbon atoms to form a geometrically spherical compound) and nitrogen atoms (or ions thereof or radicals thereof) added to at least a portion of the spherical carbon molecules inside or outside. (This product may be referred to as the first nitrogen-containing carbonaceous material of the present invention hereinafter.)

The present invention is directed also to a nitrogen-containing carbonaceous material which comprises a plurality of spherical carbon molecules represented by Cₙ (where n denotes an integer which permits carbon atoms to form a geometrically spherical compound) which are joined to each other through a nitrogen atom or its ion or radical. (This product may be referred to as the second nitrogen-containing carbonaceous material of the present invention hereinafter.)

The present invention is directed also to a process for producing a nitrogen-containing carbonaceous material, the process comprising a step of exciting nitrogen molecules with a high-frequency plasma in a nitrogen-containing atmosphere, thereby forming radicals or ions of nitrogen atoms, a step of vaporizing spherical carbon molecules represented by Cₙ (where n denotes an integer which permits carbon atoms to form a geometrically spherical compound), and a step of reacting the radicals or ions of the nitrogen atoms with the spherical carbon molecules.

As mentioned above, the process according to the present invention comprises a step of exciting nitrogen molecules with a high-frequency plasma in a nitrogen-containing atmosphere, thereby forming radicals or ions of nitrogen atoms, a step of vaporizing spherical carbon molecules represented by Cₙ, and a step of reacting the radicals or ions of the nitrogen atoms with the spherical carbon molecules. Therefore, it permits one to produce easily the nitrogen-containing carbonaceous material of the present invention which has a new structure and which will supersede the above-mentioned conventional nitrogen-endohedral fullerenes.

The nitrogen-containing carbonaceous material according to the present invention is composed of the spherical carbon molecule and a nitrogen atom (or its ion or radical) added to at least part of the spherical carbon molecule inside or outside. Alternatively, it is composed of the spherical carbon molecules which are joined to each other through a nitrogen atom or its ion or radical. Therefore, it will find a broader range of applications than conventional endohedral fullerenes.

### BRIEF DESCRIPTION OF THE DRAWINGS

FIG. 1A is a schematic diagram of the spherical carbon molecule C₆₀. C₆₀ has the polyhedral structure called truncated icosahedron with 60 apexes. It is a cluster consisting of 60 carbon atoms, each fixed to one of the 60 apexes.

FIG. 1B is a schematic diagram of the spherical carbon molecule C₇₀.

FIG. 2A is a schematic diagram showing a fullerene molecule having a radical or ion of a nitrogen atom attached to the outside of its spherical structure.

FIG. 2B is a schematic diagram showing a fullerene molecule having a radical or ion of a nitrogen atom attached to the outside of its spherical structure.

FIG. 2C is a schematic diagram showing a fullerene molecule having a radical or ion of a nitrogen atom attached to the inside of its spherical structure.

FIG. 2D is a schematic diagram showing a fullerene molecule having a radical or ion of a nitrogen atom attached to the inside of its spherical structure.

FIG. 2E is a schematic diagram showing a fullerene molecule having a radical or ion of a nitrogen atom encapsulated in its spherical structure.

FIG. 2F is a partly enlarged schematic diagram showing the spherical carbon molecule C₆₀. This figure indicates the site formed by fused rings to which the radical or ion of the nitrogen atom attaches itself on the fullerene molecule.

FIG. 3 is a partly enlarged schematic diagram showing the spherical carbon molecule C₇₀. This figure indicates the site formed by fused rings to which the radical or ion of the nitrogen atom attaches itself.

FIG. 4A is a schematic diagram showing a dimer of the nitrogen containing carbonaceous material according to the present invention. It is to be noted that two fullerene molecules C₆₀ are joined together through a radical or ion of a nitrogen atom outside the spherical structure of the fullerene molecule C₆₀.

FIG. 4B is a schematic diagram showing a dimer of the nitrogen containing carbonaceous material according to the present invention. It is to be noted that two fullerene molecules C₆₀ are joined together through a radical or ion of a nitrogen atom.

FIG. 4C is a schematic diagram showing a dimer of the nitrogen containing carbonaceous material according to the present invention. It is to be noted that two fullerene molecules C₆₀ are joined together through two nitrogen atom radicals and/or their ions.

FIG. 4D is a schematic diagram showing a dimer of the nitrogen containing carbonaceous material according to the present invention. It is to be noted that two fullerene molecules C₆₀ are joined together through two nitrogen atom radicals and/or their ions.

FIG. 4E is a schematic diagram showing a dimer of the nitrogen containing carbonaceous material according to the present invention. It is to be noted that two fullerene molecules C₆₀ are joined together through two nitrogen atom radicals and/or their ions.

FIG. 4F is a schematic diagram showing a dimer of the nitrogen containing carbonaceous material according to the present invention. It is to be noted that two fullerene molecules C₆₀ are joined together through two nitrogen atom radicals and/or their ions.

FIG. 5A is a schematic diagram showing the bonding of the nitrogen-containing carbonaceous material (in dimer form) according to the present invention. This dimer is formed when the nitrogen-containing carbonaceous material having a radical or ion of a nitrogen atom attached to the outside of the spherical structure of the fullerene molecule C₆₀ joins with a fullerene molecule C₆₀ through the radical or ion of the nitrogen atom.

FIG. 5B is a schematic diagram showing the bonding of the nitrogen-containing carbonaceous material (in dimer form) according to the present invention. This dimer is formed when two units of the nitrogen-containing carbonaceous material each having a radical or ion of a nitrogen atom attached to the outside of the spherical structure of the fullerene molecule C₆₀ join together through the radicals or ions of the nitrogen atoms.

FIG. 6 is an IR spectrum of the nitrogen-containing carbonaceous material according to the present invention.

FIG. 7 is a TOF-MS graph of the nitrogen-containing carbonaceous material according to the present invention.

FIGS. 8A and 8B are TOF-MS graphs of the nitrogen-containing carbonaceous material according to the present invention.

FIG. 9 is a schematic diagram showing N-endohedral fullerene molecule C₆₀ and its electronic structure. The spin orbit exists in the HOMO-LUMO gap of fullerene molecule.

FIG. 10 is a sectional view of the apparatus which is suitably used for production of the nitrogen-containing carbonaceous material according to the present invention. Nitrogen gas is introduced into the chamber through the nitrogen gas outlet. The high-frequency electrode generates plasma, which vaporizes the fullerene molecules placed in the molybdenum boat provided with a heater.

FIG. 11 is a schematic sectional view showing an example of the solar cell to which is applied the nitrogen-containing carbonaceous material of the present invention. The solar cell is made up of a glass substrate coated with an ITO film, an electrically conductive polymer layer, an electron acceptor layer of the nitrogen-containing carbonaceous material, and a patterned aluminum electrode.

### DETAILED DESCRIPTION OF THE PREFERRED EMBODIMENT

In the present invention, the above-mentioned spherical carbon molecules Cₙ should preferably be fullerene molecules.

Fullerene molecule is a generic name given to a series of spherical carbon molecules composed solely of carbon. It consists of 12 five-membered rings and an arbitrary number of six-membered rings.

In other words, fullerene molecule is a spherical carbon molecule composed of carbon atoms joining together to form a cluster. The number of carbon atoms is selected from 60, 70, 76, 84, etc. which are just enough to form a geometrically spherical structure.

The above-mentioned spherical carbon molecule Cₙ should preferably have a carbon number n of 60 or 70. However, the one having a carbon number n of 76 or 84 may also give the nitrogen-containing carbonaceous material with desired properties of the invention.

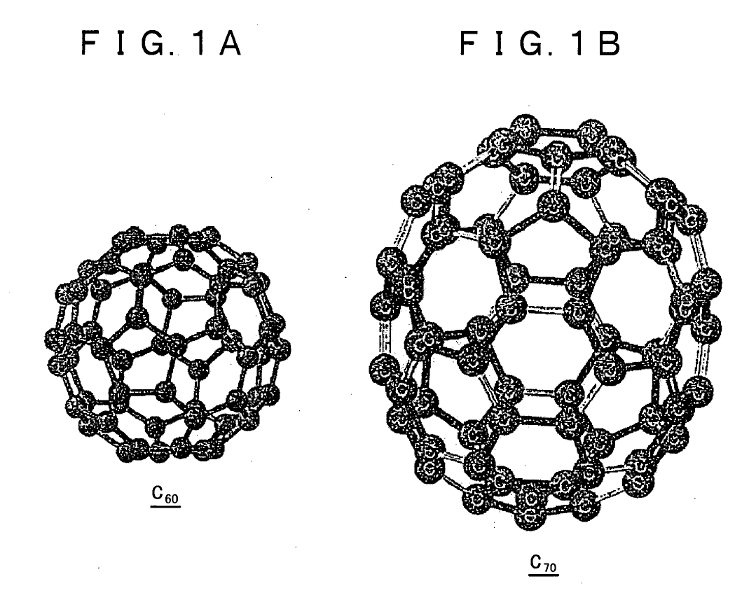

For example, the spherical carbon molecule Cₙ represented by C₆₀, which has a carbon number n of 60, has the polyhedral structure called truncated icosahedron with 60 apexes as shown in FIG. 1A. It is a cluster consisting of 60 carbon atoms, each fixed to one of the 60 apexes.

The spherical carbon molecule Cₙ represented by C₇₀ has a carbon number n of 70. It is schematically shown in FIG. 1B.

The nitrogen-containing carbonaceous material according to the present invention should preferably be constructed such that the nitrogen atom (or its ion or radical) is attached to that site of the spherical carbon molecule at which the six-membered ring and the five-membered ring fuse together.

Also, the nitrogen-containing carbonaceous material according to the present invention should preferably be constructed such that a plurality of the spherical carbon molecules are polymerized through the nitrogen atom (or its ion or radical).

The production process according to the present invention should preferably be carried out in such a way that the high-frequency plasma is generated by a high-frequency electric power no higher than 100 W in a nitrogen atmosphere at a pressure no higher than about 133 Pa (1 Torr).

The preferred embodiments of the invention will be described in more detail with reference to the accompanying drawings.

As mentioned above, conventional fullerenes with encapsulated typical elements are usually prepared by ion implantation. This process, however, is so poor in yields as to develop their application.

A new process to supersede ion implantation has been proposed, and it has been reported that nitrogen-endohedral fullerenes and other endohedral fullerenes can be produced by means of capacitively-coupled high-frequency plasma. (Huang, H.; Ata, M.; Ramm, M. J.; Chem. Soc. Chemical Commun. 2076-77 (2002))

The plasma process is more suitable for mass production than ion implantation because of its simplicity.

The following deals with how encapsulation of nitrogen into fullerene molecules takes place in plasma.

Unlike photoexcitation, plasma excitation does not depend on the symmetry of molecules.

Therefore, plasma provides an extremely large cross-section of excitation even for highly symmetrical molecules, and this leads to efficient excitation.

Particularly, plasma readily produces excited nitrogen molecules and forms a large amount of excited species such as nitrogen cations swinging in the high-frequency electric field.

In other words, plasma easily excites nitrogen molecules from the ground state X¹Σ_{g}⁺ to the electron excited triplet state ΔA³Πᵤ.

It is considered that nitrogen molecules in the electron excited triplet state ΔA³Πᵤ change into nitrogen cations and radicals through the following process.
N₂*(A³Πᵤ)+e*→N(radical)+N⁺+2e

In excitation from the ground state to the triplet state, the spin functions are orthogonal.

Consequently, such excitation is not achieved by light but is achieved very easily by plasma.

In one conceivable situation, excited species (or radicals or ions of nitrogen atoms) collide with fullerene molecules (or spherical carbon molecules), thereby attaching themselves to the outside of the spherical structure of the fullerene molecule.

Table 1 below shows the spin multiplicity and the standard enthalpy of formation which are possessed by each of fullerene molecule (as spherical carbon molecule) such as C₆₀ and C₇₀, nitrogen radical (N), nitrogen ion (N⁺), and nitrogen molecule (N₂)

TABLE 1

| | AM-1 | PM-3 |
|---|---|---|
| | ΔH_{f}⁰ | ΔH_{f}⁰ |
| Compounds | kcal/mol | kcal/mol |
| N radical (quadruplet) | 113.0 | 113.0 |
| N radical (doublet) | 177.1 | 156.7 |
| N⁺ (triplet) | 417.3 | 419.3 |
| N₂ (singlet) | 11.1 | 17.5 |
| C₆₀ (singlet) | 972.7 | 883.5 |
| C₇₀ (singlet) | 1061.3 | 811.1 |

The standard enthalpy of formation in Table 1 was calculated by using MOPAC package for the semiempirical molecular orbital method, in which the parameter sets are AM-1 and PM-3.

Incidentally, AM-1 and PM-3 are the sets of atomic parameters used in calculation by the semiempirical molecular orbital method, which is called the MNDO method designed to handle only electrons in the valence state.

Table 2 below also shows the standard enthalpy of formation which is possessed by the nitrogen-containing carbonaceous material of the present invention and the fullerene molecule C₆₀ with encapsulated nitrogen.

TABLE 2

| | AM-1 | | PM-3 | |
|---|---|---|---|---|
| | ΔH_{f}⁰ (kcal/mol) | | ΔH_{f}⁰ (kcal/mol) | |
| Compounds | outside | inside | outside | inside |
| C₆₀ | 972.7 | | 811.0 | |
| C₆₀N-(66) | 1001.2 | 1127.0 | 843.5 | 944.9 |
| C₆₀N-(56) | 996.5 | 1146.0 | 827.9 | 955.4 |

| | | |
|---|---|---|
| N-endohedral C₆₀ (doublet) | 1107.1 | 943.9 |
| N-endohedral C₆₀ (quadruplet) | 1075.0 | 921.1 |

The nitrogen-containing carbonaceous material shown in Table 2 is one which is composed of fullerene molecules C₆₀ (as spherical carbon molecules) shown in FIG. 1A and radicals or ions of nitrogen atoms attached to the outside or inside of the spherical structure.

Incidentally, the nitrogen-containing carbonaceous open-shell material according to the present invention was calculated on the assumption that the ground spin multiplicity is in the doublet state and the endohedral fullerene is calculated for the quadruplet state (in which the atomic nature is large) and the doublet state (in which the mutual action of outer cages is large).

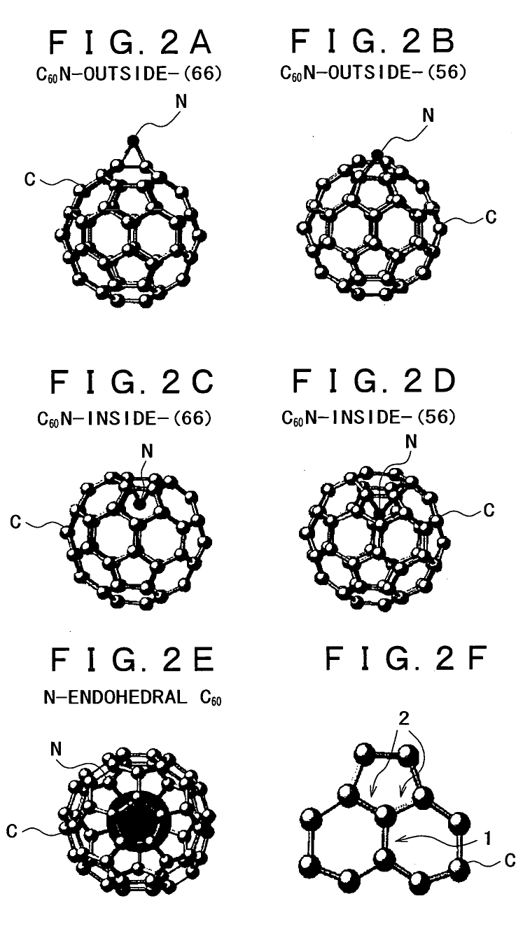

The nitrogen-containing carbonaceous material according to the present invention and the endohedral fullerene, which are listed in Table 2, are schematically shown in FIGS. 2A to 2E.

Incidentally, the term “inside” or “outside” used in Table 2 and FIGS. 2A to 2E means that the radical or ion of the nitrogen atom attaches itself to the fullerene molecule inside or outside the spherical structure of the fullerene molecule. (The same shall apply hereinafter.)

The symbol “66” means that the radical or ion of the nitrogen atom attaches itself to the site (1) shown in FIG. 2F at which two six-membered rings of the fullerene molecule fuse together. (The same shall apply hereinafter.)

Also, the symbol “56” means that the radical or ion of the nitrogen atom attaches itself to the site (2) shown in FIG. 2F at which one six-membered ring and one five-membered ring of the fullerene molecule fuse together. (The same shall apply hereinafter.)

It is apparent from Table 2 that addition of nitrogen to the site at which the five-membered ring and the six-membered ring fuse together is easier than addition of nitrogen to the site at which the two six-membered rings fuse together. This is of great interest.

This differs from the fact that ordinary addition reaction takes place at the site at which two six-membered rings of fullerene molecule fuse together, the site clearly showing the properties of double bond.

It is also understood that the nitrogen-containing carbonaceous material of the present invention, which has a radical or ion of a nitrogen atom attached to the outside of the spherical structure of the fullerene molecule (as shown in FIG. 2A or 2B) becomes highly unstable when the radical or ion of the nitrogen atom enters (by puckering) the inside of the spherical structure of the fullerene molecule.

It is also understood that the nitrogen-containing carbonaceous material of the present invention, which has a radical or ion of a nitrogen atom attached to the inside of the spherical structure of the fullerene molecule (as shown in FIG. 2C or 2D) shifts to the endohedral fullerene (as shown in FIG. 2E) through the process toward stabilization.

The endohedral fullerene (as shown in FIG. 2E) is less stable than the nitrogen-containing carbonaceous material of the present invention, which has a radical or ion of a nitrogen atom attached to the outside of the spherical structure of the fullerene molecule (as shown in FIG. 2A or 2B).

By contrast, the endohedral fullerene (as shown in FIG. 2E) is more stable than the nitrogen-containing carbonaceous material of the present invention, which has a radical or ion of a nitrogen atom attached to the inside of the spherical structure of the fullerene molecule (as shown in FIG. 2C or 2D).

Moreover, the endohedral fullerene is more stable when its spin multiplicity is in the quadruplet state than when its spin multiplicity is in the doublet state.

This indicates that the nitrogen atom remains in its atomic state without charge transfer in the absolute vacuum space. It is considered that this phenomenon is due to the specificity of mutual action in the nano space or due to the fact that adsorptive mutual action in the nano space takes place not through a wall or but through a space.

Table 3 below shows the heat of reaction which is generated in the course of formation of the nitrogen-containing carbonaceous material and endohedral fullerene according to the present invention.

TABLE 3

| | | | PM-3 | |
|---|---|---|---|---|
| | | | | ΔH_{f} (r)/ |
| | AM-1 | | | radical |
| | ΔH_{f}⁰ (r)/ion | ΔH_{f} (r)/radical | ΔH_{f}⁰ (r)/ion | kcal/ |
| Compounds | kcal/mol | kcal/mol | kcal/mol | mol |
| C₆₀N-outside-(66) | −388.8 | −84.5 | −386.8 | −80.5 |
| C₆₀N-outside-(56) | −393.5 | −89.2 | −402.4 | −96.1 |
| C₆₀N-inside-(66) | −260.3 | +41.3 | −285.4 | +20.9 |
| C₆₀N-inside-(56) | −244.0 | +60.3 | −274.9 | +31.4 |
| N-endohedral C₆₀ | −315.0 | −10.7 | −309.2 | −2.9 |

In Table 3, ΔH_{f}⁰ (r)/ion and ΔH_{f} (r)/radical denote respectively the heat of the ion addition reaction represented by C₆₀ +N⁺ (triplet)+e and the heat of the radical addition reaction represented by C₆₀ +N (radical) (quadruplet).

It is apparent from Table 3 that the formation of endohedral fullerene is exothermic, although not so significant as the formation of the nitrogen-containing carbonaceous material according to the present invention, which has a radical or ion of a nitrogen atom attached to the spherical structure of the fullerene molecule.

At the present, however, it is only possible to obtain the endohedral fullerene in its complete form with a probability of 1/10000. It is like a product of chance.

Addition of a radical or ion of a nitrogen atom to the outside of the spherical structure of the fullerene molecule takes place easily.

Therefore, the nitrogen-containing carbonaceous material according to the present invention, which has a radical or ion of a nitrogen atom attached to the spherical structure of the fullerene molecule, is considered to exist in large quantities.

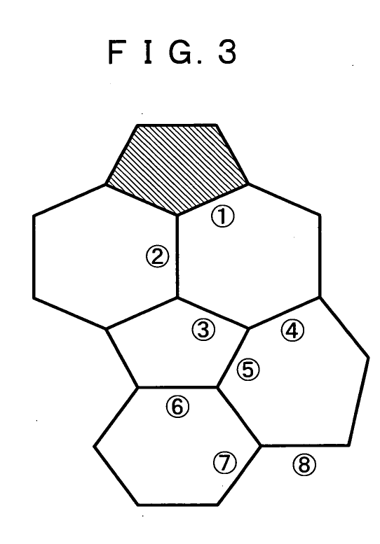

The following deals with the fullerene molecule C₇₀ as the spherical carbon molecule mentioned above. C₇₀ has eight kinds of sites formed by fused rings, as shown in FIG. 3.

Table 4 below shows the standard enthalpies of formation which are possessed by the nitrogen-containing carbonaceous material of the present invention in which a nitrogen atom of an ion thereof attaches itself to the site formed by fused rings (see FIG. 3), and by the nitrogen-endohedral fullerene.

TABLE 4

| | AM-1 | | PM-3 | |
|---|---|---|---|---|
| | ΔH_{f}⁰ (kcal/mol) | | ΔH_{f}⁰ (kcal/mol) | |
| Compounds | outside | inside | outside | inside |
| C₇₀ | 1061.2 | | 883.4 | |
| C₇₀N-\mathring{1} | 1069.1 | 1213.4 | 907.5 | 1009.3 |
| C₇₀N-\mathring{2} | 1082.8 | 1213.4 | 892.7 | 1009.3 |
| C₇₀N-\mathring{3} | 1055.4 | 1213.4 | 880.1 | 1009.3 |
| C₇₀N-\mathring{4} | 1072.2 | 1190.4 | 896.6 | 1010.5 |
| C₇₀N-\mathring{5} | 1061.4 | 1209.6 | 885.6 | 988.7 |
| C₇₀N-\mathring{6} | 1060.1 | 1192.5 | 884.9 | 999.7 |
| C₇₀N-\mathring{7} | 1073.5 | 1178.0 | 896.9 | 985.7 |
| C₇₀N-\mathring{8} | 1057.1 | 1191.5 | 879.8 | 1005.8 |

| | | |
|---|---|---|
| N-endohedral C₇₀ (doublet) | 1169.8 | 991.6 |
| N-endohedral C₇₀ (quadruplet) | 1137.7 | 969.7 |

Remarks:
The symbols \mathring{1}-\mathring{8} that follow after each compound name denote the sites formed by fused rings as shown in FIG. 2.

It is apparent from Table 4 that, of the nitrogen-containing carbonaceous materials according to the present invention which have the nitrogen atom or its ion or radical attached to the sites \mathring{1}-\mathring{3} formed by fused rings of the C₇₀ fullerene molecule, those which have the nitrogen atom or its ion or radical attached to the inside of the spherical structure of the C₇₀ fullerene molecule assume the same structure.

The nitrogen-containing carbonaceous material which has the nitrogen atom or its ion or radical attached to the inside of the spherical structure of the C₇₀ fullerene molecule is characterized in that the nitrogen can move around freely inside the spherical structure.

As in the case of C₆₀ mentioned above, in the case of C₇₀, too, addition reaction takes place preferentially at the site formed by fused rings which is not involved in ordinary addition reaction.

It is suggested that encapsulation of nitrogen in C₇₀ is a process which stabilizes the nitrogen-containing carbonaceous material, which has a nitrogen atom or its ion or radical attached to the inside of the spherical structure of the fullerene molecule C₇₀.

It has been mentioned above that the nitrogen-endohedral fullerene is formed only with a very low probability. One reason for this is the possibility of polymerization of the nitrogen-containing carbonaceous material having the nitrogen atom or its ion or radical attached to the outside of the spherical structure of the fullerene molecule.

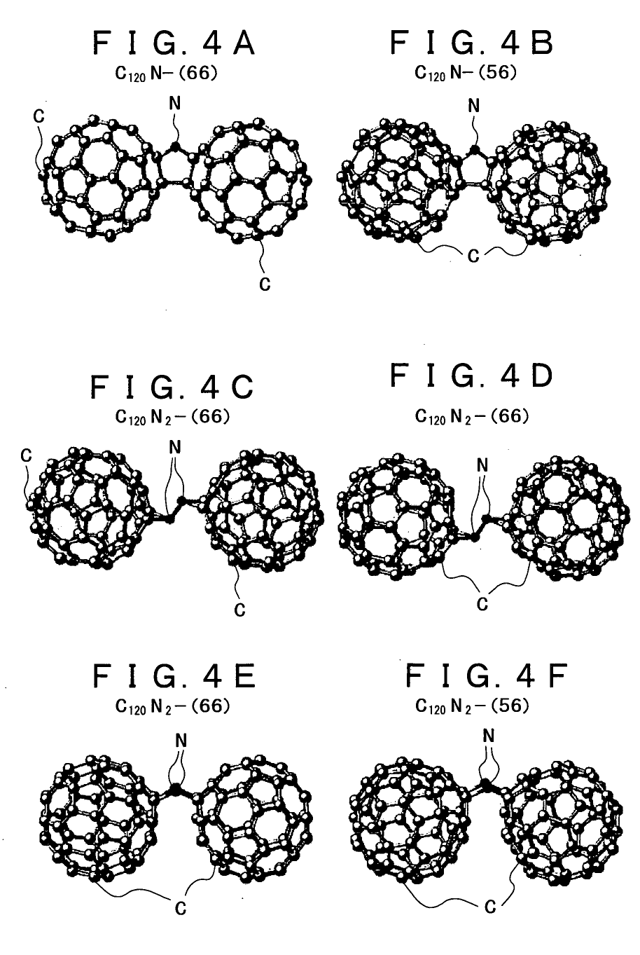

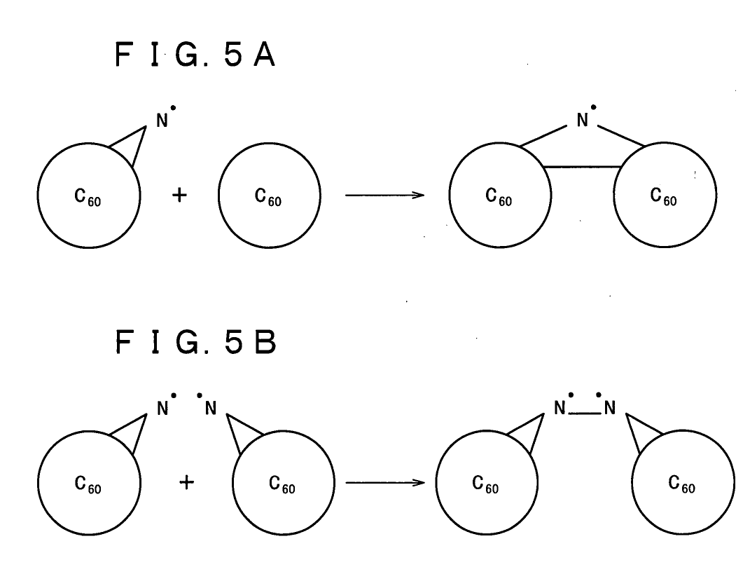

To ascertain the reason, researches were conducted to examine, from the standpoint of thermodynamics, whether or not the polymer (dimer) shown in FIG. 4 can be formed.

FIGS. 4A and 4B each shows a dimer of the nitrogen-containing carbonaceous material according to the present invention. This dimer is formed when the nitrogen-containing carbonaceous material having a radical or ion of a nitrogen atom attached to the outside of the spherical structure of the fullerene molecule C₆₀ joins with a fullerene molecule C₆₀ through the radical or ion of the nitrogen atom.

Here, the nitrogen atom interposed between the two fullerene molecules is a radical, which is stable in this state.

FIGS. 4A to 4F each shows a dimer of the nitrogen-containing carbonaceous material according to the present invention. This dimer is formed when two units of the nitrogen-containing carbonaceous material each having a radical or ion of a nitrogen atom attached to the outside of the spherical structure of the fullerene molecule C₆₀ join together through the radicals or ions of the nitrogen atoms.

Incidentally, the nitrogen-containing carbonaceous materials shown in FIGS. 4C to 4F correspond to the designations of dimmers shown in Table 5 below.

TABLE 5

| | AM-1 | | PM-3 | |
|---|---|---|---|---|
| | | ΔH_{f} (r)/ | | ΔH_{f} (r)/ |
| | ΔH_{f}⁰ | reaction heat | ΔH_{f}⁰ (r) | reaction heat |
| Dimers | kcal/mol | kcal/mol | kcal/mol | kcal/mol |
| C₁₂₀N-(66)^{a)} | 1905.4 | −68.5 | 1578.5 | −76.0 |
| C₁₂₀N-(56)^{b)} | 1927.6 | −41.6 | 1597.9 | −41.0 |
| C₁₂₀N₂-(66)^{c)} | 2009.8 | +7.4 | 1671.9 | −15.1 |
| C₁₂₀N₂-(56)^{d)} | 2010.5 | +17.5 | 1668.9 | +13.1 |
| C₁₂₀N₂-(66)^{e)} | 2019.4 | +17.0 | 1647.9 | −7.9 |
| C₁₂₀N₂-(56)^{f)} | 2060.2 | +67.2 | 1689.4 | +33.6 |

The nitrogen-containing carbonaceous material according to the present invention, which is shown in FIG. 4, is formed by addition polymerization of C₆₀Ns with each other (in the case of C₁₂₀N₂) or by radical addition of C₆₀N and C₆₀ (in the case of C₁₂₀N).

Table 5 shows the standard enthalpy of formation of each dimer shown FIG. 4. Table 5 also shows the heat of radical addition reaction of N<C₆₀+C₆₀ for the dimer C₁₂₀N-(66) shown in FIG. 4A and the dimer C₁₂₀N-(56) shown in FIG. 4B. Table 5 also shows the heat of reaction of radical dimerization of N<C₆₀+N<C₆₀ for the dimer C₁₂₀N₂-(66) shown in FIGS. 4C and 4E and the dimer C₁₂₀N₂-(56) shown in FIGS. 4D and 4F.

The standard enthalpy of formation and the reaction heat, which are shown in Table 5, suggest that those polymers having the structure of C₁₂₀N-(66) shown in FIG. 4A and C₁₂₀N-(56) shown in FIG. 4B are formed easily and stably.

Therefore, deposits on the electrode are expected to appreciably contain polymers resulting from radical addition polymerization.

Deposits on the electrode are insoluble in organic solvents. However, they may exist in an amorphous form due to damages by sputtering. (The effect of sputtering should be significant on the electrode.)

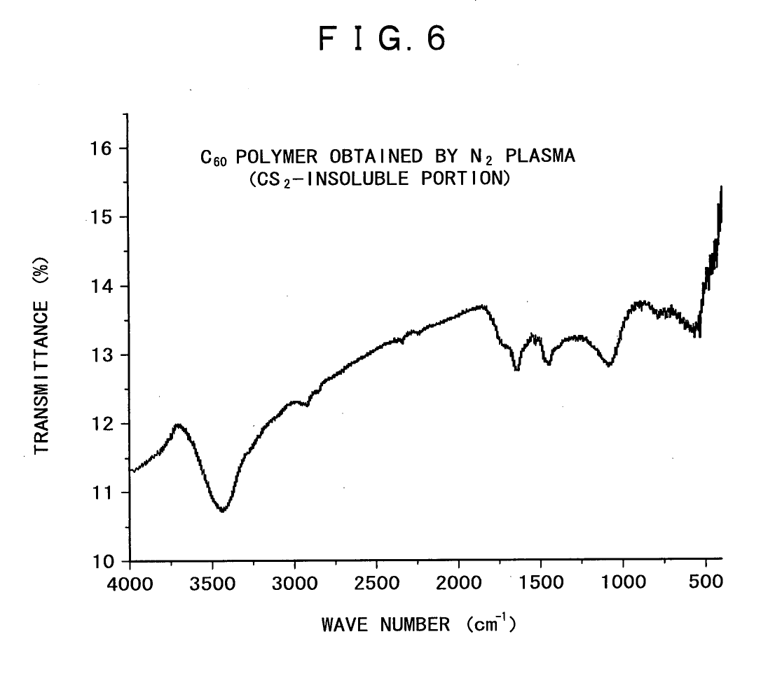

FIG. 6 is an IR spectrum of the nitrogen-containing carbonaceous material according to the present invention.

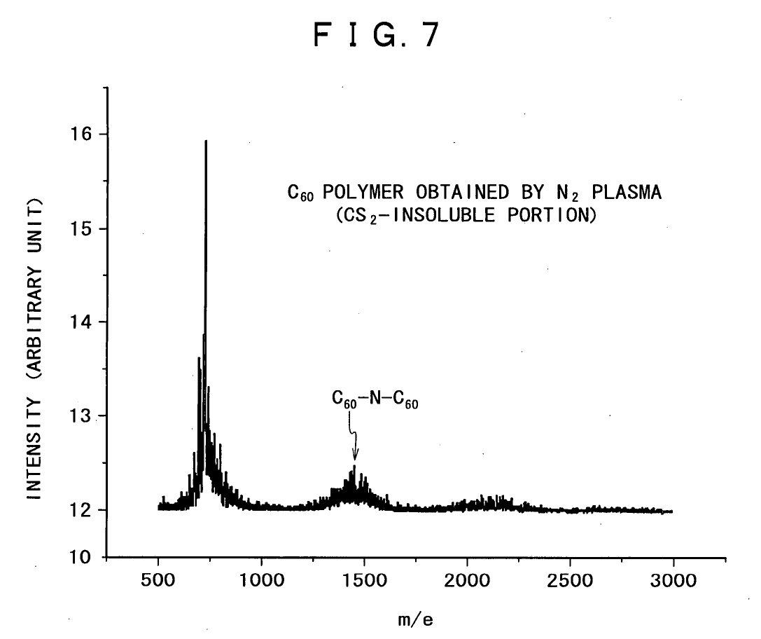

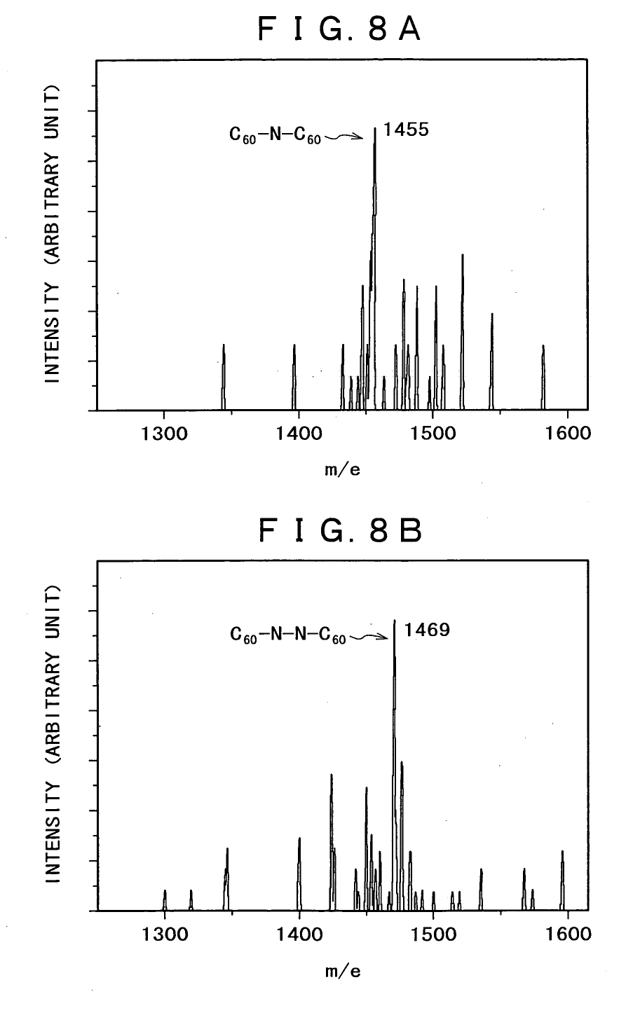

FIGS. 7 and 8 are TOF-MS graphs of the nitrogen-containing carbonaceous material according to the present invention.

As shown in FIG. 7, the maximum peak in the range of mass of the dimer corresponds to C₆₀—N—C₆₀.

FIG. 8 is a spectrum in the range of mass corresponding to the dimer. It apparently has the mass peaks corresponding to C₆₀—N—C₆₀ and C₆₀—N—N—C₆₀, respectively.

FIG. 8A is a spectrum observed at the edge of ablation threshold, and FIG. 8B is a spectrum observed, with the laser power raised a little more.

The maximum peak in FIG. 8A corresponds to C₆₀—N—C₆₀, and the maximum peak in FIG. 8B corresponds to C₆₀—N—N—C₆₀.

These results suggest that the structure predicted by the calculations mentioned above is correct.

Now, the following deals with the structure from the standpoint of electronic structure.

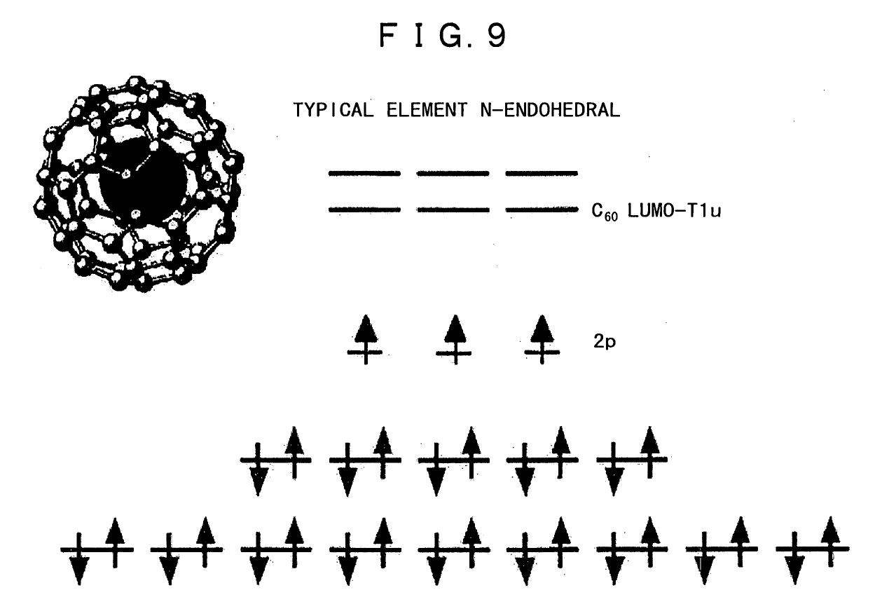

FIG. 9 is a diagram showing the electronic structure of N-endohedral fullerene molecule C₆₀.

The spin orbit exists in the HOMO-LUMO gap of fullerene molecule.

In other words, electrons exist in the band gap.

The foregoing about nitrogen-endohedral fullerene is applicable also to the nitrogen-containing carbonaceous material (in dimer form) according to the present invention.

As mentioned above, the polymers represented respectively by C₁₂₀N-(66) in FIG. 4A and by C₁₂₀N-(56) in FIG. 4B, which are expected to have a stable dimer structure, have the open-shell structure at the nitrogen atom, and unshared electron pairs exist there. This means that electrons exist excessively.

A fullerene polymer receives stresses at the crosslinking site in the initial stage of crosslinking. Therefore, it is expected to transform from dumbbell to peanut and further to tube through repeated Stone-Wales transition.

The fact that this transform actually occurs has been proved by the process through which C₆₀ inside the cylindrical structure of carbon nanotube (CNT) is transformed into nanotube when so-called “peapod” (in which fullerene molecules are encapsulated in carbon nanotubes) is heated.

The dimer structure mentioned above surely occurs; however, the relaxation of the crosslink structure is a subject for future investigation.

However, it is predicted that extra electrons are surely supplied to the neighborhood of the band gap from the valence of nitrogen even though nitrogen bridge forms crosslinking or nitrogen relaxes to such an extent that it supports part of the sphere.

The production process according to the present invention employs high-frequency plasma in a nitrogen-containing atmosphere. This high-frequency plasma is useful for making n-type fullerene polymer film. The nitrogen-containing carbonaceous material according to the present invention, which is produced by this process, possesses outstanding properties of semiconductors.

The nitrogen-containing carbonaceous material according to the present invention has an adequate quantity of nitrogen atoms added thereto in the form of ion or radical. The ratio of ion and radical could be controlled by plasma treatment on nitrogen gas diluted with inert gas.

The relaxation of structure of the crosslinking part could be adjusted by the plasma power.

In the production process according to the present invention, the plasma process easily excites nitrogen. Nitrogen ions (cations) N⁺ and nitrogen atom radicals play an important role in conversion of a nitrogen-containing carbonaceous material in monomer form into a nitrogen-containing carbonaceous material in polymer form and also in formation of endohedral fullerenes.

The process with high-frequency plasma, which is used to form the nitrogen-containing carbonaceous material and the nitrogen-endohedral fullerene according to the present invention, indicates that the self-bias effect manifests itself around the high-frequency electrode. Therefore, the electrode should preferably have a three-dimensional structure which is easily affected by self-bias.

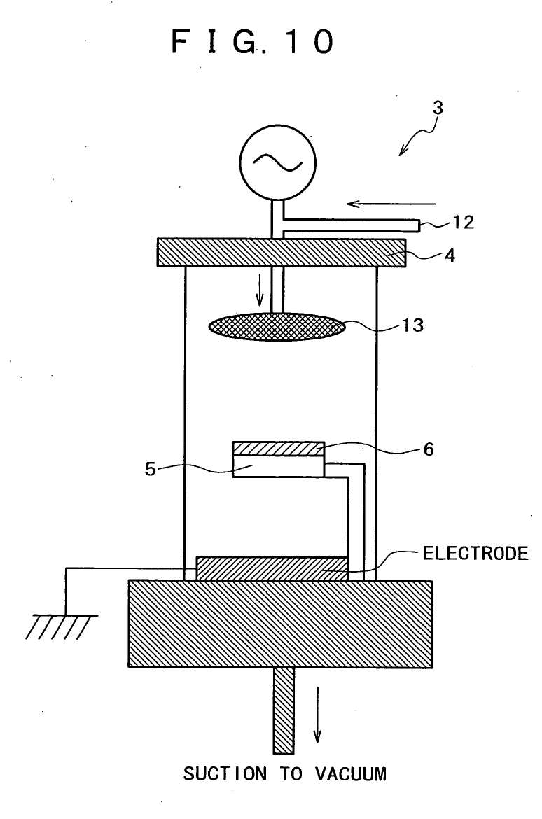

FIG. 10 is a schematic sectional view of the capacitively-coupled high-frequency plasma treatment apparatus which is suitably used for production of the nitrogen-containing carbonaceous material according to the present invention.

This apparatus has a nitrogen gas inlet 12, through which nitrogen gas is introduced. The chamber 3 is filled with nitrogen gas discharged from a nitrogen gas outlet 13.

At the upper part of the chamber 3 is a high-frequency electrode 4, which generates plasma.

The thus generated plasma vaporizes fullerene molecules 6 placed in a molybdenum boat 5 provided with a heater, which is installed at the center of the chamber 3.

The output of plasma should preferably be in a range of about 30 to 50 W. Plasma with an output in excess of 100 W tends to cause fragmentation to fullerene molecules.

On the other hand, excessively weak plasma does not generate nitrogen atom radicals efficiently.

It is considered that polymerization proceeds in proportion of the duration of plasma irradiation.

The above-mentioned plasma process effectively forms nitrogen cations and radicals and hence permits easy and mass production of the nitrogen-containing carbonaceous material according to the present invention.

As mentioned above, the first nitrogen-containing carbonaceous material according to the present invention, which is a monomer in the open-shell state, is capable of radical addition polymerization with fullerene molecules.

The fullerene polymer having such a structure is expected to function as an n-type semiconductor. It will be applicable to photodiodes or solar cells.

The solar cell may be of Schottky type, donor-acceptor type having an electrically conductive polymer, such as electron-donating polythiophene, or DMA type (donor-excitonic middle layer-acceptor) having a sensitizer-containing layer.

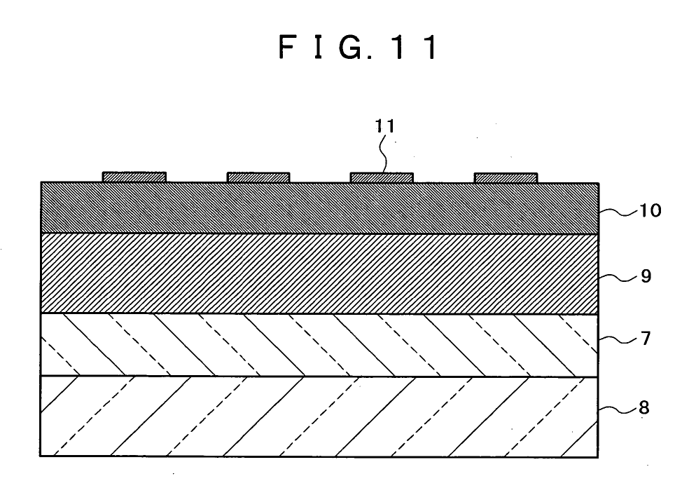

FIG. 11 is a schematic sectional view of the solar cell in which the electron acceptor layer is the nitrogen-containing carbonaceous material according to the present invention.

As shown in FIG. 11, the solar cell has a laminate structure consisting of a glass substrate 8, which is coated with an ITO (indium tin oxide) film 7 (200 nm thick) and a layer 9 (250 nm thick) containing an electrically conductive polymer (such as poly(3-octyl)thiophene: P30P).

On this layer 9 is formed an electron acceptor layer 10 (150 nm thick) composed of the nitrogen-containing carbonaceous material of the present invention (which is a fullerene polymer, for example).

On the electron acceptor layer 10 is formed a patterned aluminum electrode 11 (2 mm×2 mm). The direction of incident light is not restricted.

The nitrogen-containing carbonaceous material of the present invention, particularly in the form of fullerene polymer, which is used for the electron acceptor layer 10 in the solar cell, will contribute to electron attracting power.

While the invention has been described in its preferred embodiments, it is to be understood that modifications will occur to those skilled in the art without departing from the spirit thereof.

For example, the second nitrogen-containing carbonaceous material according to the present invention, which is a dimer, may be replaced by a trimer, a tetramer, or a higher polymer.

Also, the capacitively-coupled plasma treatment apparatus mentioned above may be replaced by an inductively-coupled plasma treatment apparatus.

Exploitation in Industry

The production process according to the present invention includes a step of exciting nitrogen molecules with a high-frequency plasma in a nitrogen-containing atmosphere, thereby forming radicals or ions of nitrogen atoms, a step of vaporizing spherical carbon molecules, and a step of reacting the radicals or ions of the nitrogen atoms with the spherical carbon molecules. Therefore, it easily forms the nitrogen-containing carbonaceous material of the present invention which has a new structure differing from that of nitrogen-endohedral fullerenes.

The nitrogen-containing carbonaceous material of the present invention has a nitrogen atom or its ion or radical attached to the outside or inside of the spherical carbon molecule at at least part thereof. Alternatively, it consists of a plurality of the spherical carbon molecules which are joined together through the nitrogen atoms or their ions or radicals. Therefore, it will find use in a broad range of applications.

While the preferred embodiments of the present invention have been described using the specific terms, such description is for illustrative purpose only, and it is to be understood that changes and variations may be made without departing from the spirit or scope of the following claims.

1. A nitrogen-containing carbonaceous material which comprises a plurality of spherical carbon molecules represented by Cₙ (where n denotes an integer which permits carbon atoms to form a geometrically spherical compound) and nitrogen atoms (or their ions or radicals) added to at least a portion of said spherical carbon molecules inside or outside.

2. The nitrogen-containing carbonaceous material as defined in claim 1, wherein said nitrogen atom or its ion or radical is attached to the site at which the six-membered and five-membered rings of the spherical carbon molecule fuse together.

3. A nitrogen-containing carbonaceous material which comprises a plurality of spherical carbon molecules represented by Cₙ (where n denotes an integer which permits carbon atoms to form a geometrically spherical compound), which are joined together through a nitrogen atom or its ion or radical.

4. The nitrogen-containing carbonaceous material as defined in claim 3, wherein said spherical carbon molecules are polymerized through said nitrogen atom or its ion or radical.

5. The nitrogen-containing carbonaceous material as defined in claim 3, wherein said nitrogen atom or its ion or radical is attached to the site at which the six-membered and five-membered rings of the spherical carbon molecule fuse together.

6. A process for producing a nitrogen-containing carbonaceous material, said process comprising a step of exciting nitrogen molecules with a high-frequency plasma in a nitrogen-containing atmosphere, thereby forming radicals or ions of nitrogen atoms, a step of vaporizing spherical carbon molecules represented by Cₙ (where n denotes an integer which permits carbon atoms to form a geometrically spherical compound), and a step of reacting said radicals or ions of nitrogen atoms with said spherical carbon molecules.

7. The process for producing a nitrogen-containing carbonaceous material as defined in claim 6, wherein said process gives a nitrogen-containing carbonaceous material in which a nitrogen atom or its ion or radical attaches to at least part of said spherical carbon molecule inside or outside the spherical structure of said spherical carbon molecule.

8. The process for producing a nitrogen-containing carbonaceous material as defined in claim 7, wherein said nitrogen atom or its ion or radical is attached to the site at which the six-membered and five-membered rings of the spherical carbon molecule fuse together.

9. The process for producing a nitrogen-containing carbonaceous material as defined in claim 6, wherein said process gives a nitrogen-containing carbonaceous material in which said spherical carbon molecules are joined together through said nitrogen atom or its ion or radical.

10. The process for producing a nitrogen-containing carbonaceous material as defined in claim 9, wherein said process gives a nitrogen-containing carbonaceous material in which said spherical carbon molecules are polymerized through said nitrogen atom or its ion or radical.

11. The process for producing a nitrogen-containing carbonaceous material as defined in claim 6, wherein said high-frequency plasma is generated by a high-frequency electric power no higher than 100 W in a nitrogen gas atmosphere at a pressure no higher than about 133 Pa (1 Torr).
